(19) United States
(12) Patent Application Publication
(10) Pub. No.: US 2012/0138219 A1
(43) Pub. Date: Jun. 7, 2012

(54) PROCESS FOR PRODUCING MULTILAYER COMPOSITE STRUCTURES

(75) Inventors: Paul Andrew Simpson, Mannheim (DE); Jürgen Herrmann, Neustadt (DE); Lothar Wefers, Oberaudorf (DE)

(73) Assignee: BASF SE, Ludwigshafen (DE)

(21) Appl. No.: 13/308,819

(22) Filed: Dec. 1, 2011

Related U.S. Application Data
(60) Provisional application No. 61/419,266, filed on Dec. 3, 2010.

(30) Foreign Application Priority Data
Dec. 10, 2010 (EP) 10194560.8

(51) Int. Cl. B32B 37/24; B29C 33/00; B29C 35/08

(52) U.S. Cl. 156/245; 264/400; 249/187.1

(57) ABSTRACT

Process for producing multilayer composite structures, which comprises carrying out the following operations in succession:
(a) use of power-modulated laser engraving to provide, to a female or male mold, a surface structure in the form of an image or of a pattern, where this has at least one element (D) which is not a geometric element, not a numeral, and not a letter, and where, within the surface structure, there are differences in screen angles, in depression depth, or in taper values,
(b) optional molding of a female mold from the male mold,
(c) spray-application of a plastics formulation onto the female mold, where the temperature of the female mold is in the range from 50 to 200° C.,
(d) solidification of the plastics formulation to give a film,
(e) bonding the film to a substrate (A),
(f) and removal of the mold,
where the operations (e) and (f) can be carried out in any desired sequence.

The present invention relates to a process for producing multilayer composite structures, which comprises carrying out the following operations in succession:
(a) use of power-modulated laser engraving to provide, to a female or male mold, a surface structure in the form of an image or of a pattern, where this has at least one element (D) which is not a geometric element, not a numeral, and not a letter, and where, within the surface structure, there are differences in screen angles, in depression depth, or in taper values,
(b) optional molding of a female mold from the male mold,
(c) spray-application of a plastics formulation onto the female mold, where the temperature of the female mold is in the range from 50 to 200° C.,
(d) solidification of the plastics formulation to give a film,
(e) bonding the film to a substrate (A),
(f) and removal of the mold,

where the operations (e) and (f) can be carried out in any desired sequence.

The present invention further relates to multilayer composite structures comprising
(A) a substrate,
(B) optionally at least one bonding layer, and
(C) a plastics layer with a surface structure on the visible side thereof,

where plastics layer (C) has, on the visible side thereof, at least one image or pattern,

where this has at least one element (D) which is not a geometric element, not a numeral, and not a letter,

and where, within the surface structure, there are differences in screen angles, in depression depth, or in taper values.

The present invention further relates to molds.

Numerous substrates are provided with a coating in order to achieve a particularly attractive appearance and a particularly pleasant hand (haptic quality). Coatings that have proven particularly versatile here use polymeric films. Polymeric films are generally versatile and, if the material is appropriate, can also be printed in order to achieve an effect that is of interest.

WO 2005/47549 discloses a process which can coat leather. Molds are produced, and have been provided with a pattern, and a plastics dispersion is applied to these when the mold is warm. By way of example, it is possible to obtain natural or synthetic leather with a pleasant hand. WO 2005/47549 does not disclose any coated leather that has complicated images.

WO 2006/092440 discloses a process which can produce coated leathers, the coating of which has small crinite features. These leathers have a velvety surface with pleasant hand. However, in many instances the process disclosed is unable to apply complicated images with adequate quality.

WO 2007/033968 and WO 2008/017690 disclose processes which use a laser to engrave, for example, numerals, letters, or logos into a mold and then use the mold to produce a film which is applied to a substrate. However, in many instances the process disclosed is unable to apply complicated images with adequate quality.

WO 2009/106503 discloses a process for providing, to textile surfaces, a coating which corresponds, for example, to a grained leather or to a woodgrain. To this end, a polyurethane layer, previously produced on a mold, is applied. The polyurethane layer has small crinite features which by way of example have a circular cross section and a conical shape.

It is an object to provide a process which can produce composite structures and which can also transfer complicated images with sufficient quality to coated substrates, without any need to make sacrifices in terms of hand and appearance of the surface.

The process defined in the introduction has accordingly been discovered.

The expression “multilayer composite structures” hereinafter means materials which
(A) have at least one substrate and
(C) have at least one plastics layer,

where these have been bonded to one another.

Numerous materials are suitable as substrate (A), examples being metal foils, paper, cardboard, paperboard, wood, thermoplastic moldings, and preferably natural leather, textile, nonwovens, synthetic leather, paper, and wood.

The bond between substrate (A) and plastics layer (C) can take various forms, for example that of a coherent film or of points, strips, or a grid, for example a square-shaped or honeycomb-shaped or diamond-shaped grid.

Multilayer composite structures produced by the process of the invention comprise at least one substrate (A) and at least one plastics layer (C), with a complicated image on the visible side thereof.

For the purposes of the present invention, the expression “complicated or complex images” here means images which have at least one element (D) which is present once or repeatedly on the visible side of the substrate coated in the invention and which is not a geometric element, not a numeral, and not a letter. Possible examples of elements (D) of this type are animals, plants, human beings, inclusive of portraits of human beings, buildings of non-geometric design, for example cathedrals, automobiles, landscapes, shapes of countries, cartoon characters, and in particular depictions of celebrities from sport or the arts.

For the purposes of the present invention, the expression “complicated patterns” means patterns which have at least one element (D) which occurs once or repeatedly and which is not a geometric element, examples being animals, plants, human beings, inclusive of portraits of human beings, buildings of non-geometric design, for example cathedrals, automobiles, landscapes, shapes of countries, cartoon characters, and depictions of celebrities from sport or the arts.

For the purposes of the present application, a grain pattern of a leather, and woodgrain per se are neither a complicated image nor a complicated pattern.

Examples of geometric elements are circles, ellipses, in each case entire or in part, squares, rectangles, parallelograms, trapeziums, triangles, regular pentagons, regular hexagons, regular octagons, and straight or non-straight lines.

In one embodiment of the present invention, complicated images comprise at least one element (D) and at least one geometric element.

In another embodiment of the present invention, complicated images comprise at least one element (D) but no geometric element.

In one preferred embodiment of the present invention, the complicated image has no regular repeating units. This means that—unlike in patterns such as those of a wallpaper—the motifs are not constantly repeated.

In another embodiment of the present invention, complicated patterns have certain repeating units which preferably comprise element (D).

In one embodiment of the present invention, the image or pattern can have, in addition to element (D), at least one further element selected from geometric elements, numerals, and letters.

In one embodiment of the present invention, the image or pattern can represent a combination of two different patterns which are contiguous. By way of example, the image or pattern can represent a grain pattern of a leather associated with a pattern of a woven or of a knit, for example by virtue of an imitated seam, or without any seam.

In one embodiment of the present invention, the pattern, or preferably the image, is generated by elevations or depressions with a height and, respectively, depth in the range from 1 to 3000 μm, where these create a different appearance through variations in screening, through variations in geometries (shapes), or through variations in heights or depths.

In one embodiment of the present invention, the elevations and, respectively, depressions differ individually or preferably groupwise in having different geometries, different heights and, respectively, depths, or different screening.

The process of the invention includes a plurality of steps, and these are described below.

In a first step, also termed step (a) below, power-modulated laser engraving is used to provide, to a female or male mold, a surface structure in the form of an image or of a pattern, where this has at least one element (D) which is not a geometric element, not a numeral, and not a letter, and where, within the surface structure, there are differences in screen angles, in depression depth, or in taper values.

Male and female molds can be selected from numerous materials.

By way of example it is therefore possible to select metal molds, examples of suitable metals being nickel, chromium, and aluminum. Plastics molds are also suitable, for example made of polyurethane, polyamide, or polyvinyl alcohol (PVA). Preference is given to molds which include at least one polymeric material as binder, and very particular preference is given to silicone molds.

In one embodiment of the present invention, male molds are selected from plastics molds for example made of polyurethane, polyamide, or polyvinyl alcohol.

In one embodiment of the present invention, female molds are selected from silicone molds.

In one embodiment of the present invention, male molds are selected from pre-exposed plastics molds, for example made of polyurethane, polyamide, or polyvinyl alcohol.

The meaning of the expression “made of polyurethane”, “made of polyvinyl alcohol”, or “made of polyamide” here is that more than half of the relevant mold is made of polyurethane, polyvinyl alcohol or, respectively, polyamide, but that the mold can also comprise other substances, for example fillers, preservatives, antioxidants, and/or coatings.

In one embodiment of the present invention, molds in plate form are selected, preferably female molds. In another embodiment of the present invention, molds are selected which have been attached to a cylinder, or molds are selected which themselves have cylindrical shape. Molds which have cylindrical shape are preferably seamless. Molds which have cylindrical shape have particularly good suitability for a continuous variant of the process of the invention.

In one embodiment of the present invention, a mold is selected which has an elastomeric layer or a layer composite comprising an elastomeric layer on a support, where the elastomeric layer comprises a binder and also optionally further additives and auxiliaries. Production of this type of mold can then comprise the following steps:
1) application of a liquid binder which optionally comprises additives and/or auxiliaries to a surface provided with an image or with a pattern, for example to a male mold,
2) hardening of the liquid binder, for example via thermal hardening or radiation curing, or via aging,
3) separation of the resultant mold and optionally application to a support, for example a metal plate or a metal cylinder.

In one embodiment of the present invention, the procedure applies a liquid silicone to a surface provided with an image or with a pattern, the silicone is allowed to age and thus to harden, and it is then peeled away. The resultant silicone foil is then adhesive-bonded on an aluminum support.

In one preferred embodiment of the present invention, a mold is provided which has a laser-engravable layer or a layer composite comprising a laser-engravable layer on a support, where the laser-engravable layer comprises a binder and also optionally further additives and auxiliaries. The laser-engravable layer is preferably moreover elastomeric.

In one preferred embodiment, the production of a mold comprises the following steps:
1) provision of a laser-engravable layer or of a layer composite comprising a laser-engravable layer on a support, where the laser-engravable layer comprises a binder, and also preferably additives and auxiliaries,
2) thermochemical, photochemical, or actinic hardening of the laser-engravable layer,
3) use of power-modulated laser engraving to provide, to the laser-engravable layer, a surface structure.

The laser-engravable layer, which is preferably elastomeric, or the layer composite can be present on a support, and it is preferable that they are present on a support. Examples of suitable supports comprise wovens and foils made of polyethylene terephthalate (PET), polyethylene naphthalate (PEN), polybutylene terephthalate (PBT), polyethylene, polypropylene, polyamide, or polycarbonate, preference being given to PET foils or PEN foils.

Papers and knits, for example made of cellulose, are also suitable as supports. Supports used can also comprise conical or cylindrical tubes made of the said materials, known as sleeves. Other materials suitable for sleeves are glass fiber wovens or composite materials made of glass fibers and of polymeric materials. Metallic supports, for example solid supports made of aluminum, nickel, of magnetizable spring steel or other types of steel, or of other iron alloys, and in the form of woven materials, sheets, or cylinders are also suitable support materials.

In one embodiment of the present invention, the support can have been coated with an adhesive layer to improve adhesion of the laser-engravable layer. In another embodiment of the present invention, no adhesive layer is required.

The laser-engravable layer comprises at least one binder which can be a prepolymer which reacts to give a polymer during the course of thermochemical hardening. Suitable binders can be selected, for example in respect of hardness, elasticity, or flexibility in accordance with the desired properties of the laser-engravable layer or of the mold. Suitable binders can in essence be divided into 3 groups, without any intention that the binders be restricted thereto.

The first group comprises binders having ethylenically unsaturated groups. The ethylenically unsaturated groups can be crosslinked photochemically, thermochemically, by means of electron beams, or by any desired combination of said processes. It is also possible to use mechanical hardening by means of fillers. Examples of binders of this type are those which comprise 1,3-diene monomers, e.g. isoprene or 1,3-butadiene. The ethylenically unsaturated group here can on the one hand function as chain unit of the polymer (1,4-incorporation), or it can have been bonded in the form of pendant group to the polymer chain (1,2-incorporation). Examples that may be mentioned are natural rubber, polybutadiene, polyisoprene, styrene-butadiene rubber, nitrile-butadiene rubber, acrylonitrile-butadiene-styrene (ABS) copolymer, butyl rubber, styrene-isoprene rubber, polychloroprene, polynorbornene rubber, ethylene-propylene-diene rubber (EPDM), and polyurethane elastomers having ethylenically unsaturated groups.

Other examples comprise thermoplastically elastomeric block copolymers made of alkenylaromatics and of 1,3-dienes. The block copolymers can involve either linear block copolymers or else radial block copolymers. They usually involve three-block copolymers of A-B-A type, but they can also involve two-block polymers of A-B type, or those having a plurality of alternating elastomeric and thermoplastic blocks, e.g. A-B-A-B-A. It is also possible to use a mixture of two or more different block copolymers. Commercially available three-block copolymers often comprise certain proportions of two-block copolymers. Diene units can have been 1,2- or 1,4-linked. It is possible to use not only block copolymers of styrene-butadiene type but also those of styrene-isoprene type. They are available commercially by way of example as Kraton®. It is also possible to use thermoplastically elastomeric block copolymers having terminal blocks made of styrene and having a random styrene-butadiene central block, these being obtainable as Styroflex®.

Other examples of binders having ethylenically unsaturated groups comprise modified binders in which crosslinkable groups are introduced into the polymeric molecule via grafting reactions.

The second group comprises binders which have functional groups. The functional groups can be crosslinked thermochemically, by means of electron beams, photochemically, or by any desired combination of said processes. It is also possible to use mechanical hardening by means of fillers. Examples of suitable functional groups comprise —Si(HR¹)O—, —Si(R¹R²)O—, —OH, —NH₂, —NHR¹, —COON, —COOR¹, —COHN₂, —O—C(O)NHR¹, —SO₃H, or —CO—. Examples of binders comprise silicone elastomers, acrylate rubbers, ethylene-acrylate rubbers, ethylene-acrylic acid rubbers, and ethylene-vinyl acetate rubbers, and also partially hydrolyzed derivatives of these, thermoplastically elastomeric polyurethanes, sulfonated polyethylenes, and thermoplastically elastomeric polyesters. R¹ and—when present—R² here are different or preferably identical, and are selected from organic groups, and in particular C₁-C₆-alkyl.

In one embodiment of the present invention, it is possible to use binders which have not only ethylenically unsaturated groups but also functional groups. Examples comprise addition-crosslinking silicone elastomers having functional and ethylenically unsaturated groups, and copolymers of butadiene with (meth)acrylates, (meth)acrylic acid or acrylonitrile, and also moreover comprise (block) copolymers of butadiene or isoprene with styrene derivatives having functional groups, for example block copolymers made of butadiene and 4-hydroxystyrene.

The third group of binders comprises those which have neither ethylenically unsaturated groups nor functional groups. Examples that may be mentioned here are polyolefins and ethylene/propylene elastomers and products obtained via hydrogenation of diene units, examples being SEBS rubbers.

Polymer layers which comprise binders without ethylenically unsaturated or functional groups generally have to be hardened by mechanical methods or with the aid of high-energy radiation, or by using a combination of these methods, in order to permit use of lasers for ideal sharp-edged structuring.

It is also possible to use a mixture of two or more binders, and these can involve either binders respectively from only one of the groups described or a mixture of binders from two or all three groups. The only restriction on the possible combinations is that no adverse effect is permitted on the suitability of the polymer layer for the laser-structuring process and for the molding procedure. By way of example, a mixture of at least one elastomeric binder which has no functional groups with at least one other binder which has functional groups or ethylenically unsaturated groups can be used with advantage.

In one embodiment of the present invention, the proportion of the binder(s) in the elastomeric layer or in the relevant laser-engravable layer is from 30% by weight to 99% by weight, based on the entirety of all of the constituents of the relevant elastomeric layer or of the relevant laser-engravable layer, preferably from 40 to 95% by weight, and very particularly preferably from 50 to 90% by weight.

The elastomeric layer or laser-engravable layer can optionally comprise reactive low-molecular-weight or oligomeric compounds. The molar mass of oligomeric compounds is generally not more than 20 000 g/mol. Reactive low-molecular-weight and oligomeric compounds will hereinafter be termed monomers for the sake of simplicity.

Monomers can on the one hand be added in order to increase the rate of photochemical or thermochemical crosslinking, or of crosslinking by means of high-energy radiation, to the extent that this is desired. When binders from the first and second group are used, it is generally not essential to add monomers for acceleration. In the case of binders from the third group, it is generally advisable to add monomers, but this would not be an essential requirement in every case.

Irrespective of the issue of crosslinking rate, it is also possible to use monomers to control crosslinking density. The networks obtained have less or greater density as a function of the nature and amount of the low-molecular-weight compounds added. Monomers that can be used are on the one hand known ethylenically unsaturated monomers. The monomers are in essence intended to be compatible with the binders and to have at least one photochemically or thermochemically reactive group. They should not be significantly volatile. The boiling point of suitable monomers is preferably at least 150° C. Particularly suitable materials are amides of acrylic acid or methacrylic acid with mono- or polyhydric alcohols, with amines, with amino alcohols, or with hydroxyethers and -esters, and other particularly suitable materials are styrene and substituted styrenes, esters of fumaric or maleic acid, and allyl compounds. Examples comprise n-butyl acrylate, 2-ethylhexyl acrylate, lauryl acrylate, 1,4-butanediol di(meth)acrylate, 1,6-hexanediol diacrylate, 1,6-hexanediol dimethacrylate, 1,9-nonanediol diacrylate, trimethylolpropane trimethacrylate, trimethylolpropane triacrylate, dipropylene glycol diacrylate, tripropylene glycol diacrylate, dioctyl fumarate, N-dodecylmaleimide, and triallyl isocyanurate.

Monomers in particular suitable for thermochemical hardening comprise reactive low-molecular-weight silicones, for example cyclic siloxanes, Si—H-functional siloxanes, siloxanes having alkoxy or ester groups, sulfur-containing siloxanes, and silanes, dialcohols, for example 1,4-butanediol, 1,6-hexanediol, 1,8-octanediol, 1,9-nonanediol, diamines, for example 1,6-hexanediamine, 1,8-octanediamine, amino alcohols, for example ethanolamine, diethanolamine, butylethanolamine, dicarboxylic acids, for example 1,6-hexanedicarboxylic acid, terephthalic acid, maleic acid, and fumaric acid.

It is also possible to use monomers which have not only ethylenically unsaturated groups but also functional groups. Examples that may be mentioned are ω-hydroxy-alkyl (meth)acrylates, for example ethylene glycol mono(meth)acrylate, 1,4-butanediol mono(meth)acrylate, and 1,6-hexanediol mono(meth)acrylate.

It is also possible, of course, to use a mixture of various monomers, as long as the properties of the elastomeric layer are not adversely affected by the mixture. The amount of added monomers is generally from 0 to 40% by weight, based on the amount of all of the constituents of the elastomeric layer or of the relevant laser-engravable layer, preferably from 1 to 20% by weight.

In one embodiment, it is possible to use one or more monomers with one or more catalysts. It is therefore possible to accelerate step 2) of provision of the mold via addition of one or more acids or via organotin compounds. Suitable organotin compounds can be: di-n-butyltin dilaurate, di-n-butyltin diactanoate, di-n-butyltin di-2-ethylhexanoate, di-n-octyltin di-2-ethylhexanoate, and di-n-butylbis(1-oxoneodecyl-oxy)stannane.

The elastomeric layer or the laser-engravable layer can moreover comprise additives and auxiliaries, for example IR absorbers, dyes, dispersing agents, antistatic agents, plasticizers, or abrasive particles. The amount of these additives and auxiliaries should generally not exceed 30% by weight, based on the amount of all of the components of the elastomeric layer or of the relevant laser-engravable layer.

The elastomeric layer or the laser-engravable layer can be composed of a plurality of individual layers. Said individual layers can have identical, approximately identical, or different material constitution. The thickness of the laser-engravable layer or of all of the individual layers together is generally from 0.1 to 10 mm, preferably from 0.5 to 3 mm. The thickness can be suitably selected as a function of technical application-related and technical machine-related process parameters of the laser-engraving procedure and of the molding procedure.

The elastomeric layer or the laser-engravable layer can optionally also have an overlayer of thickness not more than 300 μm. The constitution of this overlayer can be selected with a view to ideal engravability and mechanical stability, while the constitution of the layer located thereunder is selected with a view to ideal hardness or elasticity.

In one embodiment of the present invention, the overlayer itself is laser-engravable or is removable during the course of the laser-engraving process together with the layer located thereunder. The overlayer comprises at least one binder. It can moreover comprise an absorber for laser radiation, or else monomers or auxiliaries.

Preferred molds are silicone molds. The expression “silicone molds” hereinafter means molds produced by using at least one binder which has at least one, preferably at least three, O—Si(R¹R²)—O— groups per molecule. R¹ and R² here are different or preferably identical as defined above.

In another embodiment of the present invention, the mold used comprises a nickel mold. Suitable nickel molds consist essentially of a homogeneous nickel layer. The thickness of nickel layers can be in the range from 100 mm down to 10 mm.

By way of example, an optical laser can be selected as laser for the laser-engraving process in step (a). CO₂ lasers, Nd-YAG lasers, fiber lasers, and UV lasers are also suitable.

In the laser-engraving process in step (a), depressions are engraved or burnt in the manner of a screen into the laser-engravable layer, where individual regions of the screen can by way of example have screen dots arranged in the manner of a square or screen dots arranged in the manner of a rectangle or, for example, screen dots arranged in honeycomb patterns. The demarcation of various regions can then by way of example be achieved by differences in screen angle in various regions.

For the purposes of the present invention, depressions here are not only depressions which perforate the laser-engravable layer but also depressions which take the form of recesses.

The laser-engraving process in step (a) involves power-modulated laser engraving. This means that during the engraving process the power of the laser is not kept constant but instead is modulated in accordance with the desired depression depth. There are differences here in screen angle, depression depth, or taper values within the surface structure, i.e. the engraved surface structure. This means that individual engraved depressions or groups of different depressions respectively have different screen angles, depression depths, or taper values for the depressions, and specifically it is possible that all of the depressions are different or that the depressions differ groupwise, or that a few individual depressions are respectively different.

In one embodiment of the present invention, the laser power rating, i.e. maximum output power, of the radiation sources selected is in the range from 5 to 5000 W, preferably in the range from 10 to 2000 W, particularly preferably in the range from 50 to 500 W.

In one embodiment of the present invention, the power of the radiation source is modulated in the range from zero to 100% of the laser power rating. Modulation of this type can be carried out in the MHz region.

In one embodiment of the present invention, the number of depressions engraved per cm² is in the range from 100 to 10 000, preferably in the range from 4000 to 5000 depressions per cm².

In one embodiment of the present invention, the average depth of the engraved depressions is in the range from one to 3000 μm, preferably from 50 to 500 μm.

In one embodiment of the present invention, some depressions within the surface structure can be conical depressions, and other depressions can be cylindrical, conical, wedge-shaped, or convex.

In one embodiment of the present invention, some depressions within the surface structure can be cylindrical depressions, and other depressions can be convex or conical.

In one embodiment of the present invention, some depressions within the surface structure can have the shape of a small hemispherical bowl, and other depressions can be cylindrical, conical, wedge-shaped, or convex.

In one embodiment of the present invention, there are differences in the geometry of the depressions. This preferably means the geometry of the cross-sectional area. By way of example, depressions can have a round, elliptical, or polyhedral cross section, for example being square, triangular or rhombic, or having a cross section in the form of a regular pentagon or regular hexagon (honeycomb), or regular octagon. Other possibilities are semicircles, stars, and combinations of geometric elements.

In one embodiment of the present invention, there are differences in the screen angle between groups of depressions within the surface structure. It is therefore possible, for example, that two regions of identical or different

By virtue of the power-modulated laser-engraving process, the surface structure obtains an image or pattern which comprises at least one element (D).

The overall result of conduct of the step (a) is that a mold of the invention is obtained. The mold of the invention is a female mold or a male mold, as a function of whether the sites designed as depressions in the mold are intended likewise to be a depression in a composite structure or are intended to be an elevation—preferably resembling a small crinite structure.

After the actual laser-engraving procedure in step (a), the laser-engravable layer is optionally washed to remove engraving residues, for example with a circular washer or a linear washer, using a cleaning composition.

The method described can be used to produce the mold in the form of female mold or in the form of male mold.

In one embodiment of the present invention, conduct of the process of the invention involves a step (b): the molding of one or more female molds from the male mold produced in step (a). The molding procedure can, for example, be as follows:
1) application of a liquid binder which optionally comprises additives and/or auxiliaries to a surface provided with an image or with a pattern, for example to the positive mold,
2) hardening of the liquid binder, for example via thermal hardening or radiation curing, or via aging,
3) separation of the resultant female mold and optionally application to a support, for example a metal plate or a metal cylinder.

In another embodiment of the present invention, step (b) is omitted.

Conduct of the process of the invention involves step (c), namely spray-application of a plastics formulation to the female mold, where the temperature of the female mold is in the range from 50 to 200° C., preferably from 75 to 150° C., particularly preferably at least 90° C. The temperature measured here is the temperature measured at the beginning of the spray-application process at that surface of the mold that comes into contact with plastics formulation.

The spray-application process can be implemented once or repeatedly.

Examples of plastics formulations that can be selected are solutions of polymers, for example in organic solvent, and preferably aqueous formulations, in particular aqueous dispersions, for example aqueous suspensions or aqueous emulsions.

In the context of the plastics formulation, the term “aqueous” means that it comprises water and less than 5% by weight of organic solvent, based on the dispersion, preferably less than 1% by weight. It is particularly preferable that there is no detectable volatile organic solvent. For the purposes of the present invention, the expression “volatile organic solvents” means organic solvents which have a boiling point of up to 200° C. at atmospheric pressure.

Examples of suitable plastics in plastics formulations are: polystyrene, polyacrylates, and in particular polyurethanes. Examples of suitable polyacrylates are copolymers of (meth)acrylic acid with one or more C₁-C₁₀-alkyl (meth)acrylates, in particular with methyl acrylate, methyl methacrylate, ethyl acrylate, n-butyl (meth)acrylate, and 2-ethylhexyl (meth)acrylate.

Suitable polyurethanes are obtainable via reaction of
(i) isocyanates, preferably diisocyanates, with
(ii) compounds which are reactive toward isocyanates and which usually have a molar mass (Mw) of from 500 to 10 000 g/mol, preferably from 500 to 5000 g/mol, particularly preferably from 800 to 3000 g/mol, and
(iii) chain extenders having a molar mass of from 50 to 499 g/mol,

optionally in the presence of catalysts and/or of conventional additives.

The starting components and processes for production of the preferred polyurethanes (PUs) will be described below by way of example. Components (i), (ii), and (iii), usually used in the production of the polyurethanes (PUs), and also optional catalysts and/or additives will be described below by way of example:

Isocyanates (i) that can be used are well-known aliphatic, cycloaliphatic, araliphatic, and/or aromatic isocyanates, for example tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and/or dicyclohexylmethane 4,4′-, 2,4′-, and 2,2′-diisocyanate, diphenylmethane 2,2′-, 2,4′-, and/or 4,4′-diisocyanate (MDI), naphthylene 1,5-diisocyanate (NDI), tolylene 2,4- and/or 2,6-diisocyanate (TDI), diphenylmethane diisocyanate, dimethyldiphenyl 3,3′-diisocyanate, diphenylethane 1,2-diisocyanate, and/or phenylene diisocyanate. It is preferable to use 4,4′-MDI. Preference is also given to aliphatic diisocyanates, in particular hexamethylene diisocyanate (HDI).

Compounds (ii) used that are reactive toward isocyanates can comprise the well-known compounds reactive toward isocyanates, for example polyesterols, polyetherols, and/or polycarbonatediols, another term used to cover these being “polyols”, having molar masses (M_{w}) in the range from 500 to 8000 g/mol, preferably from 600 to 6000 g/mol, in particular from 800 to 3000 g/mol, and preferably having average functionality toward isocyanates of from 1.8 to 2.3, preferably from 1.9 to 2.2, in particular 2. It is preferable to use polyether polyols, for example those based on well-known starter substances and on conventional alkylene oxides, for example ethylene oxide, propylene 1,2-oxide, and/or butylene 1,2-oxide, preferably polyetherols based on polyoxytetramethylene (polyTHF), propylene 1,2-oxide and ethylene oxide. An advantage of polyetherols is that they have higher hydrolysis resistance than polyesterols, and polyetherols are preferred as component (ii), in particular for the production of soft polyurethanes (PU1).

Particular polycarbonatediols that may be mentioned are aliphatic polycarbonatediols, examples being 1,4-butanediol polycarbonate and 1,6-hexanediol polycarbonate.

Polyesterdiols that may be mentioned are those that can be produced via polycondensation of at least one primary diol, preferably at least one primary aliphatic diol, for example ethylene glycol, 1,4-butanediol, 1,6-hexanediol, neopentyl glycol, or particularly preferably 1,4-dihydroxymethylcyclohexane (in the form of isomer mixture), or a mixture of at least two of the abovementioned diols on the one hand and on the other hand at least one, preferably at least two, dicarboxylic acid(s) or anhydride(s) of these. Preferred dicarboxylic acids are aliphatic dicarboxylic acids, such as adipic acid, glutaric acid, and succinic acid, and aromatic dicarboxylic acids, such as phthalic acid and in particular isophthalic acid.

Polyetherols are preferably produced via formation of adducts of alkylene oxides, in particular ethylene oxide, propylene oxide, or a mixture thereof, with diols, for example ethylene glycol, propylene 1,2-glycol, butylene 1,2-glycol, 1,4-butanediol, or 1,3-propanediol, or with triols, for example glycerol, in the presence of high-activity catalysts. Examples of these high-activity catalysts are cesium hydroxide and dimetal cyanide catalysts, also termed DMC catalysts. A DMC catalyst often used is zinc hexacyanocobaltate. The DMC catalyst can be left in the polyetherol after the reaction, but is preferably removed, for example via sedimentation or filtration.

It is also possible to use a mixture of various polyols, instead of one polyol.

In order to improve dispersibility, compounds (ii) used which are reactive toward isocyanates can also comprise a proportion of one or more diols or diamines having a carboxylic acid group or sulfonic acid group (ii′), in particular the alkali metal or ammonium salts of 1,1-dimethylolbutanoic acid, 1,1-dimethylolpropionic acid, or

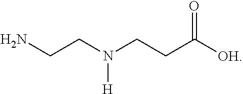

Chain extenders (iii) used comprise aliphatic, araliphatic, aromatic, and/or cycloaliphatic compounds known per se having a molar mass of from 50 to 499 g/mol and having at least two functional groups, preferably compounds having precisely two functional groups per molecule, examples being diamines and/or alkanediols having from 2 to 10 carbon atoms in the alkylene moiety, in particular 1,3-propanediol, 1,4-butanediol, 1,6-hexanediol, and/or di-, tri-, tetra-, penta-, hexa-, hepta-, octa-, nona-, and/or decaalkylene glycols having from 3 to 8 carbon atoms per molecule, and preferably corresponding oligo- and/or polypropylene glycols, and it is also possible here to use a mixture of chain extenders (iii).

It is particularly preferable that components (i) to (iii) involve difunctional compounds, i.e. diisocyanates (i), dihydric polyols, preferably polyetherols (ii) and difunctional chain extenders, preferably diols.

Suitable catalysts which in particular accelerate the reaction between the NCO groups of the diisocyanates (i) and the hydroxy groups of components (ii) and (iii) are tertiary amines known per se, e.g. triethylamine, dimethylcyclohexylamine, N-methylmorpholine, N,N′-dimethylpiperazine, 2-(dimethylaminoethoxy)ethanol, diazabicyclo[2.2.2)octane (“DABCO”), and similar tertiary amines, and also in particular organometallic compounds, such as titanic esters, iron compounds, e.g. iron(III) acetylacetonate, tin compounds, e.g. tin diacetate, tin dioctoate, tin dilaurate, or the dialkyltin salts of aliphatic carboxylic acids, dibutyltin diacetate, dibutyltin dilaurate, or the like. The amounts usually used of the catalysts are from 0.0001 to 0.1 part by weight per 100 parts by weight of component (ii).

It is also possible to add one or more auxiliaries and/or additives, alongside catalyst, to components (i) to (iii). Mention may be made of the following examples: blowing agents, antiblocking agents, surfactant substances, fillers, such as fillers based on nanoparticles, in particular fillers based on CaCO₃, and also nucleating agents, slip aids, dyes and pigments, antioxidants, e.g. with respect to hydrolysis, light, heat, or discoloration, inorganic and/or organic fillers, reinforcing agents, and plasticizers, and metal deactivators. In one preferred embodiment, hydrolysis stabilizers, such as polymeric and low-molecular-weight carbodiimides, are among the additives. It is preferable that the soft polyurethane comprises triazole and/or triazole derivative and antioxidants in an amount of from 0.1 to 5% by weight, based on the total weight of the relevant soft polyurethane. Suitable antioxidants are generally substances which inhibit or prevent undesired oxidative processes in the plastic requiring protection. Antioxidants are generally available commercially. Examples of antioxidants are sterically hindered phenols, aromatic amines, thiosynergists, organophosphorus compounds of trivalent phosphorus, and hindered amine light stabilizers. Examples of sterically hindered phenols are found in Plastics Additive Handbook, 5th edition, H. Zweifel, ed, Hanser Publishers, Munich, 2001 ([1]), pp. 98-107 and p. 116-p. 121. Examples of aromatic amines are found in [1], pp. 107-108. Examples of thiosynergists are given in [1], pp. 104-105 and pp. 112-113. Examples of phosphites are found in [1], pp. 109-112. Examples of hindered amine light stabilizers are given in [1], pp. 123-136. Phenolic antioxidants are preferably suitable for use in the antioxidant mixture. In one preferred embodiment, the molar mass of the antioxidants, in particular of the phenolic antioxidants, is greater than 350 g/mol, particularly preferably greater than 700 g/mol, and their maximum molar mass (M_{w}) is up to at most 10 000 g/mol, preferably up to at most 3000 g/mol. Their melting point is moreover preferably at most 180° C. It is moreover preferable to use antioxidants which are amorphous or liquid. It is also possible to use a mixture of two or more antioxidants as additive(s).

It is also possible to use chain regulators (chain terminators), usually having a molar mass of from 31 to 3000 g/mol, alongside components (i), (ii), and (iii) mentioned and optional catalyst and additives. These chain regulators are compounds which have only one functional group reactive toward isocyanates, examples being monohydric alcohols, monobasic amines, and/or monohydric polyols. These chain regulators can be used for controlled adjustment of flow behavior, in particular in soft polyurethanes. The amount that can be used of chain regulators is generally from 0 to 5 parts by weight, preferably from 0.1 to 1 part by weight, based on 100 parts by weight of component (ii), and they are defined as part of component (iii).

Toward the end of the molecular-weight-increased reaction, It is also possible to use one or more crosslinking agents having two or more groups reactive toward isocyanate, for example hydrazine hydrate, alongside components (i), (ii), and (iii) mentioned and optional catalyst and additives.

Components (ii) and (iii) can be selected in a relatively broad range of molar ratios in order to adjust the hardness of polyurethane (PU). Examples of suitable molar ratios of component (ii) to the entirety of chain extenders (iii) to be used are from 10:1 to 1:10, in particular from 1:1 to 1:4, where the hardness of the soft polyurethanes rises with increasing content of (iii). The index used for the reaction to produce polyurethane (PU) can be from 0.8 to 1.4:1, preferably from 0.9 to 1.2:1, particularly preferably from 1.05 to 1.2:1. The index is defined via the ratio of the total number of isocyanate groups used during the reaction in component (i) to the number of groups reactive toward isocyanates, i.e. the number of active hydrogen atoms, in components (ii) and where appropriate (iii) and where appropriate monofunctional components acting as chain terminators and reactive toward isocyanates, e.g. monoalcohols.

Plastics dispersion used in step (c) can comprise, alongside plastic, other components, for example one or more surfactants, and/or one or more hardeners. Suitable hardeners are compounds which can crosslink a plurality of plastics molecules, preferably a plurality of polyurethane molecules, with one another, for example on thermal activation. Particularly suitable hardeners are those based on trimeric diisocyanates, and in particular based on aliphatic diisocyanates, such as hexamethylene diisocyanate. Examples of hardeners having very particularly good suitability are compounds described as compound (V) in WO 2009/106503.

Plastics dispersion used in step (c) can comprise, alongside plastic and optionally hardener, other compounds, for example one or more silicone compounds, where these can have no, or preferably one or more, reactive groups per molecule. Examples of reactive groups that may be mentioned are: carboxylic acid derivative groups, an example being methyl carboxylate, or carboxylic anhydrides, in particular succinic anhydride groups, and particularly preferably carboxylic acid groups.

Other examples of reactive groups are primary and secondary amino groups, for example NH(iso-C₃H₇) groups, NH(n-C₃H₇) groups, NH(cyclo-C₆H₁₁) groups, and NH(n-Calls) groups, in particular NH(C₂H₅) groups, and NH(CH₃) groups, and very particularly preferably NH₂ groups.

Preference is further given to aminoalkylamino groups, for example —NH—CH₂—CH₂—NH₂ groups, —NH—CH₂—CH₂—CH₂—NH₂ groups, —NH—CH₂—CH₂—NH(C₂H₅) groups, —NH—CH₂—CH₂—CH₂—NH(C₂H₅) groups, —NH—CH₂—CH₂—NH(CH₃) groups, —NH—CH₂—CH₂—CH₂—NH(CH₃) groups.

Other suitable additives are those selected from pigments, matting agents, light stabilizers, antistatic agents, antisoiling agent, antirattle agents, thickeners, in particular polyurethane-based thickeners, and hollow microbeads.

In one embodiment of the present invention, the solids content of a plastics formulation applied by spraying in step (c) is in the range from 1 to 50%, preferably from 25 to 35%

The spray-application of—preferably aqueous—plastics formulations to the female mold can be achieved by methods known per se, in particular via spray-application using a spray gun or using one or more spray nozzles, where these can have been incorporated fixedly or movably into an apparatus.

Various apparatuses can be used for the spray-application of—preferably aqueous—plastics formulation to the female mold. Airless spray systems and air-spray systems are particularly suitable.

The plastics formulation preferably sprayed is preferably aqueous, with a temperature in the range from 15 to 30° C., particularly from 20 to 25° C.

In one embodiment of the present invention, the dynamic viscosity at room temperature of the—preferably aqueous—plastics formulation used for the spray-application process is at most 500 mPa·s, preferably at most 200 mPa·s.

In one embodiment of the present invention, the pH of the—preferably aqueous—plastics formulation used for the spray-application process is in the range from 4 to 10, preferably in the range from 6 and 8.

In step (d), the plastics formulation which has been applied by spraying in step (b) on to the female mold is solidified to give a film. Solidification can by way of example be achieved by removing, for example via evaporation, organic solvent in which the abovementioned plastic has been formulated, or preferably the water in which the abovementioned plastic has been dispersed, suspended, or emulsified.

Step (d) can be conducted at various temperatures. Examples of suitable temperatures are from 30 to 90° C.

Step (d) can be conducted at any desired pressure, preferably atmospheric pressure.

Step (d) gives a plastic which takes the form of a film, and for the purposes of the present invention the abbreviated term “film” is also used for this material.

The thickness of the film can by way of example be from 70 to 300 μm.

In step (e), the film is bonded to a substrate (A). Substrate (A) is described in detail below. The bonding can by way of example be brought about via lamination, adhesive bonding, or welding, and reinforced by way of example via application of pressure of calendering.

The manner in which the film obtained in step (d) is bonded to substrate (A) in step (d) is, of course, such that the side provided with the pattern or image is the visible side.

By way of example, bonding is achieved in step (e) via application of an organic adhesive which is applied to the entire surface or preferably in the form of a discontinuous layer, i.e. a layer which does not cover the entire surface, preferably of an organic adhesive.

In one embodiment of the present invention, organic adhesive is applied in step (e) in the form of points, of strips, or of a grid which is by way of example diamond-shaped, rectangular, or square, or which has a honeycomb structure.

Organic adhesive can be selected from adhesives based on polyvinyl acetate, polyacrylate, or in particular polyurethane, preferably polyurethanes with a glass transition temperature below 0° C.

The organic adhesive can by way of example be cured thermally, via actinic radiation, or via aging.

In another embodiment of the present invention, an adhesive network is applied in step (e).

In another embodiment of the present invention, the maximum thickness of organic adhesive is 100 μm, preferably 50 μm, particularly preferably 30 μm, very particularly preferably 15 μm, determined after application and hardening.

In a step (f) of the process of the invention, the mold is separated, for example via mechanical peeling.

Operations (e) and (f) here can be conducted in any desired sequence. By way of example, step (e) can be conducted first and followed by step (f). In another embodiment of the present invention, step (f) is conducted first and followed by step (e).

In one embodiment of the present invention, the film from step (d) is porous.

In one preferred embodiment of the present invention, the film from step (d) has pores in the form of capillaries which extend through the entire thickness (cross section) of the film.

In one embodiment of the present invention, the average number of pores in the form of capillaries per 100 cm² in the film from step (d) is at least 100, preferably at least 250.

In one embodiment of the present invention, the average diameter of the pores in the form of capillaries is in the range from 0.005 to 0.05 mm, preferably from 0.009 to 0.03 mm.

In one embodiment of the present invention, the pores in the form of capillaries have uniform distribution in the film from step (d). In one preferred embodiment of the present invention, however, the pores in the form of capillaries have non-uniform distribution in the film from step (d).

In one embodiment of the present invention, the pores in the form of capillaries are in essence curved. In another embodiment of the present invention, the pores in the form of capillaries are in essence straight.

Pores in the form of capillaries can give the film from step (d) permeability to air and to water vapor, without any need for perforation. In one embodiment of the present invention, the permeability of the film from step (d) to water vapor can be above 1.5 mg/cm²·h, measured to DIN 53333. Moisture, such as sweat, can therefore migrate through the film from step (d).

In one embodiment of the present invention, the film from step (d) has not only the capillaries but also pores which do not extend through the entire thickness of the film.

The process of the invention can produce multilayer composite structures which have velvet-like appearance and very pleasant hand, and on which there can be images or patterns with excellent durability. These patterns or images can be complicated and can comply with sophisticated design requirements. These images or patterns can by way of example exhibit a flip-flop effect, where their appearance differs as a function of angle of observation. If they are black, they exhibit an attractively deep black color. If they use a porous film, they are permeable to water vapor and are not susceptible to sweat-staining. Images of this type can serve for protection from copying or as original identification marking, by virtue of their complexity and clever design.

The present invention further provides multilayer composite structures comprising
(A) a substrate,
(B) optionally at least one bonding layer, and
(C) a plastics layer which has small crinite features, with a surface structure on the visible side thereof,

where plastics layer (C) has, on the visible side thereof, at least one image or pattern,

where this has at least one element (D) which is not a geometric element, not a numeral, and not a letter

and where, within the surface structure, there are differences in screen angles, in depression depth, or in taper values.

Numerous materials are suitable as substrate (A), examples being metal foils, paper, cardboard, paperboard, wood, and thermoplastic moldings, preference being given to natural leather, textile, nonwovens, synthetic leather, paper, and wood. Examples of textile are wovens and knits.

The bond between substrate (A) and plastics layer (C) can take various forms, for example that of a coherent film or of points, strips, or a grid, for example a square-shaped or honeycomb-shaped or diamond-shaped grid.

The thickness of substrate (A) can be any desired thickness appropriate to the material of the substrate.

Plastics layer (C) has small crinite features.

In one embodiment of the present invention, the average thickness of plastics layer (C) is in the range from 15 to 300 μm, preferably from 20 to 150 μm, particularly preferably from 25 to 80 μm, excluding the length of the small crinite features.

The meaning of the terms image and pattern is given above, as also is a description of element (D).

In one embodiment of the present invention, the image can have, in addition to element (D), one or more geometric elements, numerals, or letters.

In one embodiment of the present invention, various portions of the image or pattern are generated via variations in three-dimensional structuring of the plastics layer (C).

In one preferred embodiment of the present invention, the image, which can preferably be complicated, has no regular repeating units. This means that—unlike in patterning such as that of a wallpaper—the motifs are not constantly repeated.

In another embodiment of the present invention, patterns have certain repeating units which preferably comprise element (D).

In one embodiment of the present invention, the image or pattern can have, in addition to element (D), at least one further element selected from geometric elements, numerals, and letters.

In one embodiment of the present invention, the image or pattern can represent a combination of two different patterns which are contiguous. By way of example, the image or pattern can represent a grain pattern of a leather which has been combined with a pattern of a woven or of a knit, for example via a simulated seam, or seamlessly. This combination then preferably corresponds to the element (D).

In one embodiment of the present invention, the pattern, or preferably the image, is generated via elevations or depressions with a height or, respectively, depth in the range from 1 to 3000 μm, where these create a different appearance through variations in screening, through variations in shapes, or through variations in heights or depths.

In one embodiment of the present invention, the elevations or, respectively, depressions differ groupwise in having different three-dimensional geometries, different heights and, respectively, depths, or different screening.

In one embodiment of the present invention, plastic layer (C) can comprise at least two different polyurethanes, which for the purposes of the present invention are also termed (C1) and (C2), where the Shore hardness A of polyurethane (C1) is in the range below 60 and this is also termed “soft polyurethane”, and where the Shore hardness A of polyurethane (C2) is in the range from above 60 to 120 and this is also termed “hard polyurethane”. Shore hardness A is determined here by way of example to DIN 53505 after 3 s.

In one embodiment of the present invention, the average particle diameter of polyurethane (C1) is in the range from 100 to 300 nm, preferably from 120 to 150 nm, determined via laser light scattering.

In one embodiment of the present invention, the average particle diameter of polyurethane (C2) is in the range from 100 to 300 nm, preferably 120 to 150 nm, determined via laser light scattering.

In one embodiment of the present invention, the hardness of polyurethane (C1) and/or polyurethane (C2) is adjusted via differences in proportions of IPDI as diisocyanate.

In one embodiment of the present invention, plastic layer (C) is impermeable to air. In another embodiment of the present invention, plastics layer (C) is porous, for example because the plastics layers has capillaries that extend through the entire thickness of the plastics layer.

Multilayer composite structures of the invention can by way of example be produced by the process of the invention, described in the introduction. Multilayer composite structures of the invention have a velvety surface with very pleasant hand. There can be images or patterns with excellent durability on composite structures of the invention. These patterns or images can be complicated and can comply with sophisticated design requirements. These images or patterns can by way of example exhibit a flip-flop effect, where their appearance differs as a function of angle of observation. If they are black, they exhibit an attractively deep black color. If they use a porous film, they are permeable to water vapor and are not susceptible to sweat-staining. Images of this type can serve for protection from copying or as original identification marking, by virtue of their complexity and clever design.

The present invention further provides a female mold which has, on one side, at least one negative of an image or pattern, where this has at least one element (D) which is not a geometric element, not a numeral, and not a letter, and where this is generated via elevations or depressions which generate a different appearance through variations in screening or variations in height or depth.

In one embodiment of the present invention, the elevations and, respectively, depressions differ individually or preferably groupwise in having different geometries, or different heights or depths, with different screening or screen angles.

Molds of the invention have very good suitability for producing multilayer composite structures of the invention. The present invention therefore further provides the use of female molds of the invention for the production of multilayer composite structures of the invention.

A process for the production of molds of the invention has been described above.

Working examples are used to illustrate the invention.

### WORKING EXAMPLES

I. Production of Molds of the Invention

A liquid silicone was poured on to a flat underlay. The material was hardened by adding to it, as acidic hardener, a 25% by weight solution of di-n-butylbis(1-oxoneodecyloxy)stannane in tetraethoxysilane, and this gave a silicone rubber layer of average thickness 2 mm which served as base for a mold. The mold material was adhesive-bonded to an aluminum support of thickness 1.5 mm.

A CO₂ laser was used to engrave circular depressions which had the characteristics given in Table 1. An acousto-optical modulator was used here to modulate the power of the radiation source.

Said characteristics differed in various regions of the mold. The arrangement of the regions generated various shading effects, thus generating the image of a footballer kicking a ball.

The product was mold 1 of the invention.

TABLE 1
Characteristics of depressions in mold 1 of the invention

| | | | Screen | | | | 3D |
|---|---|---|---|---|---|---|---|
| | Separation | Depressions/ | angle | Depression | Cylindr. | | angle |
| Region | [μm] | cm² | [°] | depth [mm] | projection | Plateau | α [°] |
| 1 | 137.6 | 5282 | 32 | 0.19 | 0.006 | 0 | 80 |
| 2 | 137.6 | 5282 | 32 | 0.13 | 0.006 | 0 | 80 |
| 3 | 137.6 | 5282 | 90 | 0.13 | 0.006 | 0 | 70 |
| 4 | 153.8 | 4228 | 32 | 0.15 | 0.006 | 0 | 70 |
| 5 | 137.6 | 5282 | 65 | 0.17 | 0.006 | 0 | 70 |
| 6 | 153.8 | 4228 | 32 | 0.15 | 0.006 | 0 | 80 |
| 7 | 125 | 6400 | 32 | 0.15 | 0.006 | 0 | 70 |

Separation means the distance between two depressions. The distance between the depressions is always the distance measured to the most adjacent depression, and specifically from depression center to depression center.

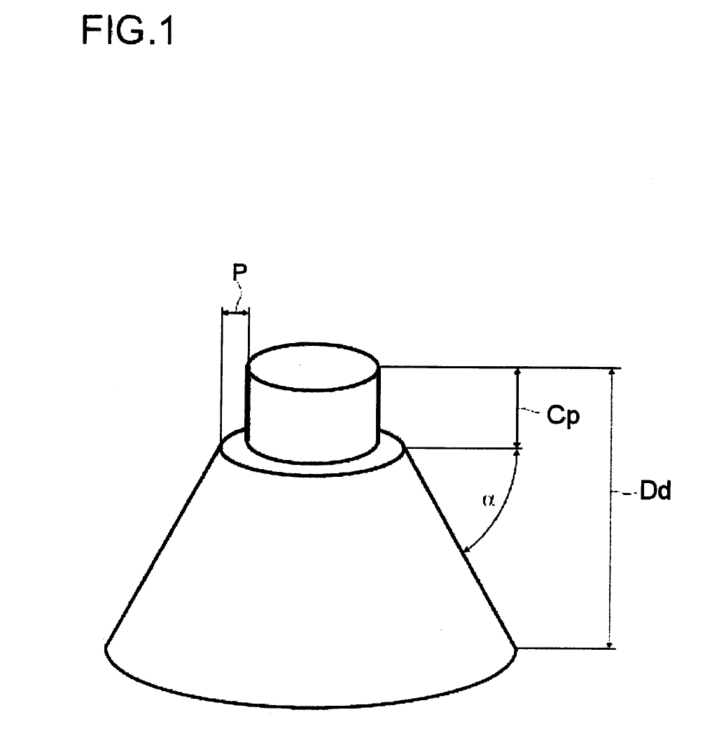

FIG. 1 provides a more detailed explanation of the terms in Table 1.

Dd: Depression depth

Cp: Cylindrical projection

P: Plateau

The product was a mold of the invention.

II. Production of Plastics Dispersions

The plastics selected were always polyurethanes.

II.1 Production of an Aqueous Polyurethane Dispersion Disp.1

The following were mixed, with stirring, in a mixer:

7% by weight of an aqueous dispersion (particle diameter: 125 nm, solids content: 40%) of a soft polyurethane (C1.1), produced from hexamethylene diisocyanate and isophorone diisocyanate in a ratio by weight of 13:10, as diisocyanates, and, as diols, a polyesterdiol of molar mass M_{w} 800 g/mol, produced via polycondensation of isophthalic acid, adipic acid, and 1,4-dihydroxymethylcyclohexane (isomer mixture) in a molar ratio of 1:1:2.5% by weight, 1,4-butanediol (b1.2), and also 3% by weight of monomethylated polyethylene glycol, and also 3% by weight of H₂N—CH₂CH₂—NH—CH₂CH₂—COOH, where each % by weight value is based on polyesterdiol (b1.1), and the softening point of soft polyurethane (C1.1) is 62° C., and softening begins at 55° C., Shore hardness A 54,

65% by weight of an aqueous dispersion (particle diameter: 150 nm) of a hard polyurethane (C2.1), obtainable via reaction of isophorone diisocyanate, 1,4-butanediol, 1,1-dimethylolpropionic acid, hydrazine hydrate, and polypropylene glycol with molar mass M_{w} 4200 g/mol, softening point 195° C., Shore hardness A 86, 3.5% by weight of a 70% by weight solution (in propylene carbonate) of compound (I.1)

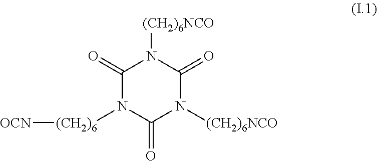

6% by weight of a 65% by weight aqueous dispersion of the silicone compound of example 2 of EP-A 0 738 747

2% by weight of carbon black,

0.5% by weight of a polyurethane-based thickener,

1% by weight of hollow microbeads made of polyvinylidene chloride, filled with isobutane, diameter 20 μm, available commercially by way of example as Expancel® from Akzo Nobel.

This gave aqueous dispersion Disp.1 with solids content 35% and kinematic viscosity 25 sec. at 23° C., determined to DIN EN ISO 2431, issued May 1996.

II.2 Production of an Aqueous Formulation Disp.2

The following were mixed, with stirring, in a mixer:

7% by weight of an aqueous dispersion (particle diameter: 125 nm, solids content: 40%) of a soft polyurethane (C1.1), produced from hexamethylene diisocyanate and isophorone diisocyanate in a ratio by weight of 13:10, as diisocyanates, and, as diols, a polyesterdiol of molar mass M_{w} 800 g/mol, produced via polycondensation of isophthalic acid, adipic acid, and 1,4-dihydroxymethylcyclohexane (isomer mixture) in a molar ratio of 1:1:2.5% by weight, 1,4-butanediol, 3% by weight of monomethylated polyethylene glycol, and also 3% by weight of H₂N—CH₂CH₂—NH—CH₂CH₂—COOH, where each % by weight value is based on polyesterdiol, and the softening point is 62° C., and softening begins at 55° C., Shore hardness A 54,

65% by weight of an aqueous dispersion (particle diameter: 150 nm) of a hard polyurethane, obtainable via reaction of isophorone diisocyanate, 1,4-butanediol (C1.2), 1,1-dimethylolpropionic acid, hydrazine hydrate, and polypropylene glycol with molar mass M_{w} 4200 g/mol, where the softening point of polyurethane (C2.2) was 195° C., Shore hardness A 90,

3.5% by weight of a 70% by weight solution (in propylene carbonate) of compound (I.1),

NCO content 12%,

2% by weight of carbon black.

This gave a polyurethane dispersion Disp.2 with solids content 35% and kinematic viscosity 25 sec. at 23° C., determined to DIN EN ISO 2431, issued May 1996.

III. Production of a Plastics Film

Mold 1 of the invention was placed on a heatable underlay and heated to 91° C. Disp.1 was then applied by spraying through a spray nozzle, and specifically at 88 g/m² (wet). The material was applied without admixture of air, using a spray nozzle of diameter 0.46 mm, at a pressure of 65 bar. The material was allowed to solidify at 91° C. until the surface was no longer tacky.

The spray nozzle had been arranged movably 20 cm from the moving underlay in the direction of movement of the same, and the nozzle moved transversely with respect to the direction of movement of the underlay. The temperature of the underlay was 59° C., and it took about 14 seconds to pass the spray nozzle. After contact with dry air heated to 85° C. for a period of about two minutes, the resultant crosslinked polyurethane film (C.1) was almost free from water.

In an analogous arrangement, the mold of the invention coated in this way was then immediately subjected to application of 50 g/m² wet of Disp.2 as bonding layer (B.1), and was then allowed to dry.

The product was a mold coated with plastics film (C.1) and bonding layer (B.1).

Disp.2 was spray-applied, specifically at 30 g/m² (wet), to a dipped coagulated polyester nonwoven (A.1), for which the abbreviated term substrate (A.1) is also used, with weight per unit area 180 g/m². The resultant sprayed substrate (A.1) was allowed to dry for some minutes.

IV. Production of a Multilayer Composite Structure of the Invention

Sprayed substrate (A.1) was then placed with the sprayed side on the still warm bonding layer (B.1) present together with plastics film (C.1) on the mold, and was pressed in a press for 15 seconds at 4 bar and 110° C. The resultant multilayer composite material MLC.1 of the invention was then taken out of the press, and the mold was removed.

The resultant multilayer composite material MLC.1 of the invention featured pleasant hand, an appearance identical with the original view of the footballer, and also breathability. The multilayer composite material MLC.1 of the invention could moreover easily be cleaned to remove soiling, such as dust.

MLC.1 exhibited the image of a footballer with high precision.

The operations of II. to IV. could be carried out repeatedly with the same mold, with no deterioration of the image.

1. A process for producing multilayer composite structures, which comprises carrying out the following operations in succession:
(a) use of power-modulated laser engraving to provide, to a female or male mold, a surface structure in the form of an image or of a pattern, where this has at least one element (D) which is not a geometric element, not a numeral, and not a letter, and where, within the surface structure, there are differences in screen angles, in depression depth, or in taper values,
(b) optional molding of a female mold from the male mold,
(c) spray-application of a plastics formulation onto the female mold, where the temperature of the female mold is in the range from 50 to 200° C.,
(d) solidification of the plastics formulation to give a film,
(e) bonding the film to a substrate (A),
(f) and removal of the mold,
where the operations (e) and (f) can be carried out in any desired sequence.

2. The process according to claim 1, wherein an optical laser is selected as laser in operation (a).

3. The process according to claim 1 or 2, wherein female molds are selected from silicone molds.

4. The process according to any of claims 1 to 3, wherein male molds are selected from plastics molds made of polyurethane, polyamide, or polyvinyl alcohol.

5. The process according to any of claims 1 to 4, wherein the laser power selected in operation (a) is in the range from 5 to 5000 W.

6. The process according to any of claims 1 to 5, wherein an aqueous polyurethane dispersion is selected as plastics formulation in operation (c) and comprises at least two different polyurethanes, where the Shore hardness A of one polyurethane (C1) is in the range below 60 and the Shore hardness A of another polyurethane (C2) is in the range from above 60 to 100.

7. The process according to any of claims 1 to 6, wherein the image or pattern also has at least one element selected from geometric elements, numerals, and letters.

8. The process according to any of claims 1 to 7, wherein the image has no regular repeating units.

9. The process according to any of claims 1 to 8, wherein the pattern or image is generated via elevations or depressions with a height or, respectively, depth in the range from 1 to 3000 μm, where these create a different appearance through variations in screening, through variations in shapes, or through variations in heights or depths.

10. The process according to any of claims 1 to 9, wherein the elevations or, respectively, depressions differ groupwise in having different geometries, different heights and, respectively, depths, or different screening.

11. The process according to any of claims 1 to 10, wherein the film from step (d) is porous.

12. A multilayer composite structure comprising
(A) a substrate,
(B) optionally at least one bonding layer, and
(C) a plastics layer which has small crinite features, with a surface structure on the visible side thereof,
where plastics layer (C) has, on the visible side thereof, at least one image or pattern, where this has at least one element (D) which is not a geometric element, not a numeral, and not a letter,
and where, within the surface structure, there are differences in screen angles, in depression depth, or in taper values.

13. The composite structure according to claim 12, wherein substrate (A) has been selected from natural leather, textile, nonwovens, paper, wood, and synthetic leather.

14. The composite structure according to claim 12 or 13, wherein the image also has geometric elements, numerals, or letters.

15. The composite structure according to any of claims 12 to 14, wherein various portions of the image or pattern are generated via variations in three-dimensional structuring of the visible side of the plastics layer (C).

16. The composite structure according to any of claims 12 to 15, wherein the image has no regular repeating units.

17. The composite structure according to any of claims 12 to 16, wherein the pattern or image has elevations or depressions, where these create a different appearance through variations in screening, or through variations in heights or depths, in the range from 1 to 3000 μm.

18. The composite structure according to any of claims 12 to 17, wherein plastics layer (C) comprises at least two different polyurethanes, where the Shore hardness A of one polyurethane (C1) is in the range below 60 and the Shore hardness A of another polyurethane (C2) is in the range from above 60 to 100.

19. The composite structure according to any of claims 12 to 18, wherein the elevations or, respectively, depressions differ groupwise in having different three-dimensional geometries, different heights and, respectively, depths, or different screening.

20. The composite structure according to any of claims 12 to 19, wherein plastics layer (C) is porous.

21. The composite structure according to any of claims 12 to 20, wherein the image or pattern represents a combination of two different patterns which are contiguous.

22. The composite structure according to claim 21, wherein the image or pattern represents the grain pattern of a leather which has been combined with a pattern of a woven or of a knit.

23. A female mold which has, on one side, at least one negative of an image or pattern, where this has at least one element (D) which is not a geometric element, not a numeral, and not a letter, and where this is generated via elevations or depressions which generate a different appearance through variations in screening or variations in height or depth.

24. The female mold according to claim 23, wherein the elevations or, respectively, depressions differ groupwise in having different geometries, different heights and, respectively, depths, or different screening.

25. The use of female molds according to claim 23 or 24 for the production of composite structures according to any of claims 12 to 20.
